(19) United States
(12) Patent Application Publication
(10) Pub. No.: US 2008/0003069 A1
(43) Pub. Date: Jan. 3, 2008

(54) Apparatus and method for removing inner member of plastic pipe joint

(76) Inventor: David John Harper, Eugene, OR (US)

Correspondence Address: STEVEN J. ADAMSON, PC, P.O. BOX 5997, PORTLAND, OR, 97228, US

(21) Appl. No.: 11/820,487

(22) Filed: Jun. 18, 2007

Related U.S. Application Data
(60) Provisional application No. 60/814,483, filed on Jun. 16, 2006.

(51) Int. Cl. B23D 77/04; B23B 5/00; B27G 15/00

(52) U.S. Cl. 408/88; 408/227

(57) ABSTRACT

A device for removing an inner pipe member of a plastic pipe joint. The device may include a housing that may be releaseably attached to the outside of a pipe joint and a blade structure provided within the housing that is configured to remove the inner member of a pipe joint. The device is configured to securely and releaseably attachment, to remove the desired pipe section without damaging other components, and to leave a finished structure that resembles the original, among other disclosed features.

### CROSS REFERENCE TO RELATED APPLICATIONS

This application claims the benefit of U.S. Provisional Application No. 60/814,483, filed Jun. 16, 2006, and having the same title and inventor as above.

### FIELD OF THE INVENTION

The present invention relates to a cutting device and method for removing the inner pipe member of a plastic pipe joint.

### BACKGROUND OF THE INVENTION

Various plastic pipe materials are known in the art and these include polyvinyl chloride (PVC) and Acrylonitrile-Butadiene-Styrene (ABS). Pieces of pipe are typically joined to each other through couplers or via the complementary configured ends of the pipe sections. The couplers and pipe ends are configured for snug fitting and adhesive is typically applied to the components for secure and/or waterproof fitting. Pipe coupling is known in the art.

There are times when it is desirable to replace a length of a pipe affixed at a joint. This may be achieved by cutting the pipe assembly at the joint and drilling or cutting out the inner pipe member, thereby configuring the structure for receipt of another section of pipe by the outer pipe member.

There are two commercially available devices for removing the inner pipe member in a pipe joint. One of these coring tools is called the “Pipe Ram.” This device has a central shaft from which circumferentially disposed blades extend. The shaft is mounted to a drill and the head inserted into the pipe joint such that the rotating blades cut the inner pipe member. A disadvantageous aspect of this device, among others, is that there is no built-in depth stop function. A user may unknowingly cut past the inner pipe member and into the outer pipe member (at its taper) or into another component of the joint assembly.

The other coring tool is the “Pipe Hog” described in U.S. Pat. No. 6,761,512 issued to Vatter. This device includes circumferentially disposed blades that cut in a plane perpendicular to the shaft and a housing that is seated onto the outer pipe member. Disadvantageous aspects of this device, among others, include that it is too long for some elbows, the central protrusion preventing the blades from reaching the lower portions of the inner pipe member, and the housing does not attach in a secure manner to the outside of the outer pipe member, permitting greater lateral movement of the blades while cutting and a more variable-sized finished opening. In addition, the horizontal blade structure does not conform to the typically tapered geometry of the remaining pipe member and thus is more likely to damage and thereby weaken the remaining pipe member.

A need thus exists for a coring tool and method for removing the inner member of a plastic pipe joint that overcomes the shortcomings of the prior art and provides (1) secure releasable mounting to the outside of a joint assembly, (2) a cutting assembly that can access and remove the inner member without damaging other components and (3) a finished cut that closely resembles the original component structure, among other features.

These and related objects of the present invention are achieved by use of an apparatus and method for removing the inner member of plastic pipe joint as described herein.

The attainment of the foregoing and related advantages and features of the invention should be more readily apparent to those skilled in the art, after review of the following more detailed description of the invention taken together with the drawings.

### BRIEF DESCRIPTION OF THE PREFERRED EMBODIMENT

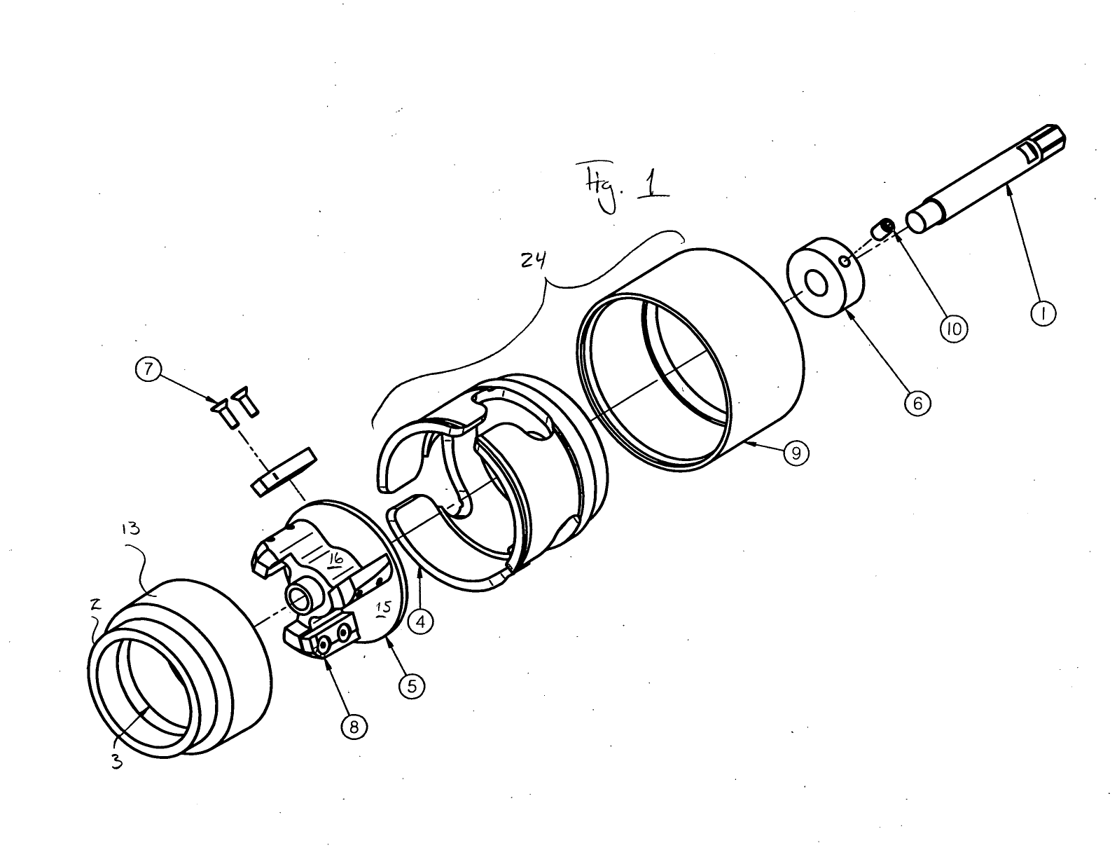

FIG. 1 is an exploded perspective view of a device for cutting the inner pipe member of a plastic pipe joint in accordance with the present invention.

FIG. 2 is a non-exploded perspective view of device in accordance with the present invention.

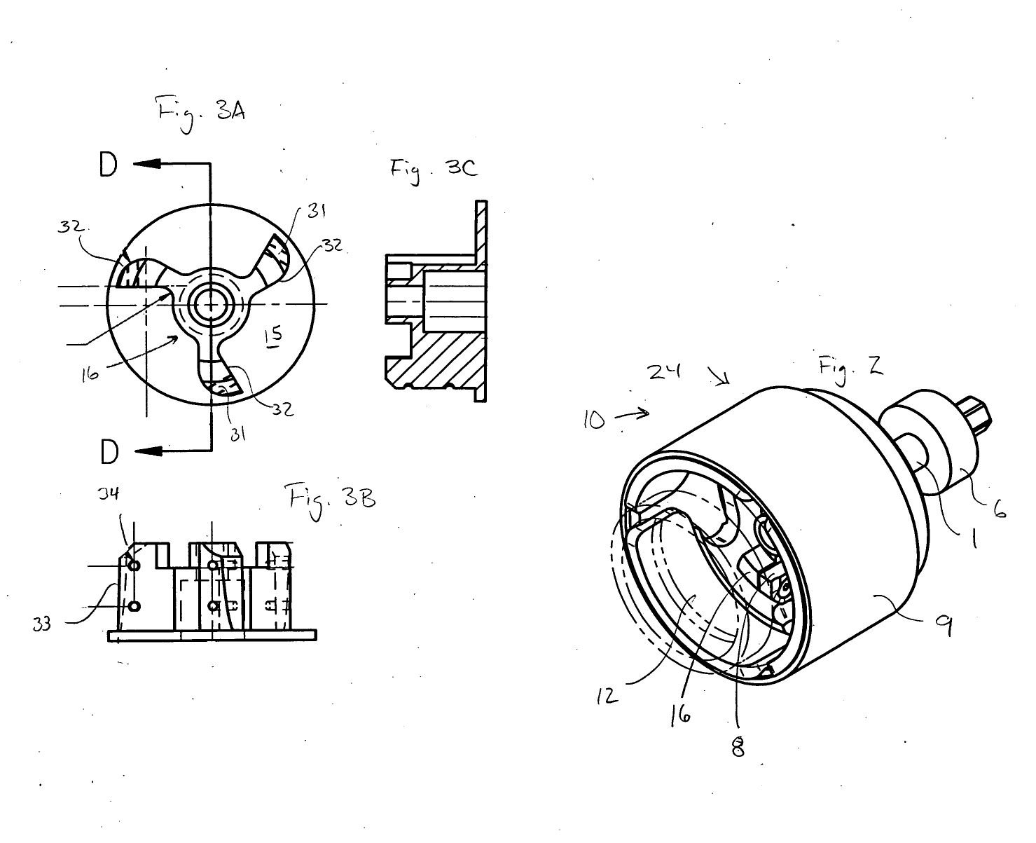

FIGS. 3A-3C are a bottom plan view, a side elevation view and a cross-sectional view, respectively, of cutter head in accordance with the present invention.

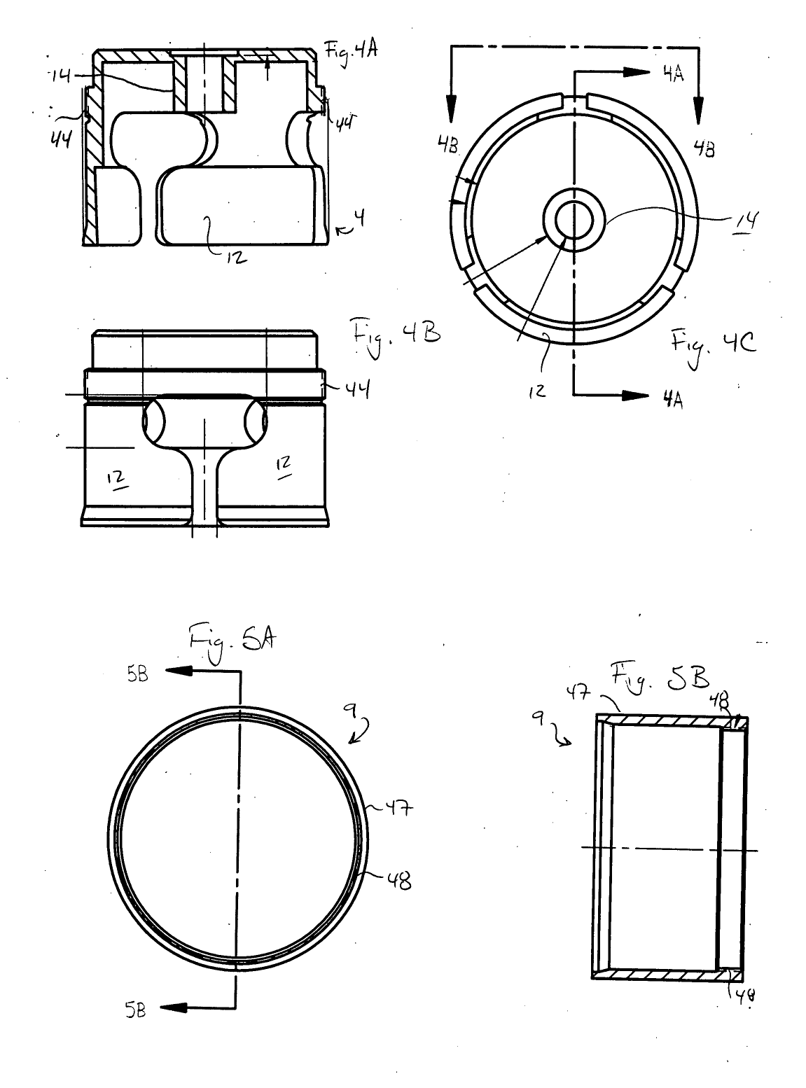

FIGS. 4A-4C and 5A-5B are various views of the component parts of a collet in accordance with the present invention.

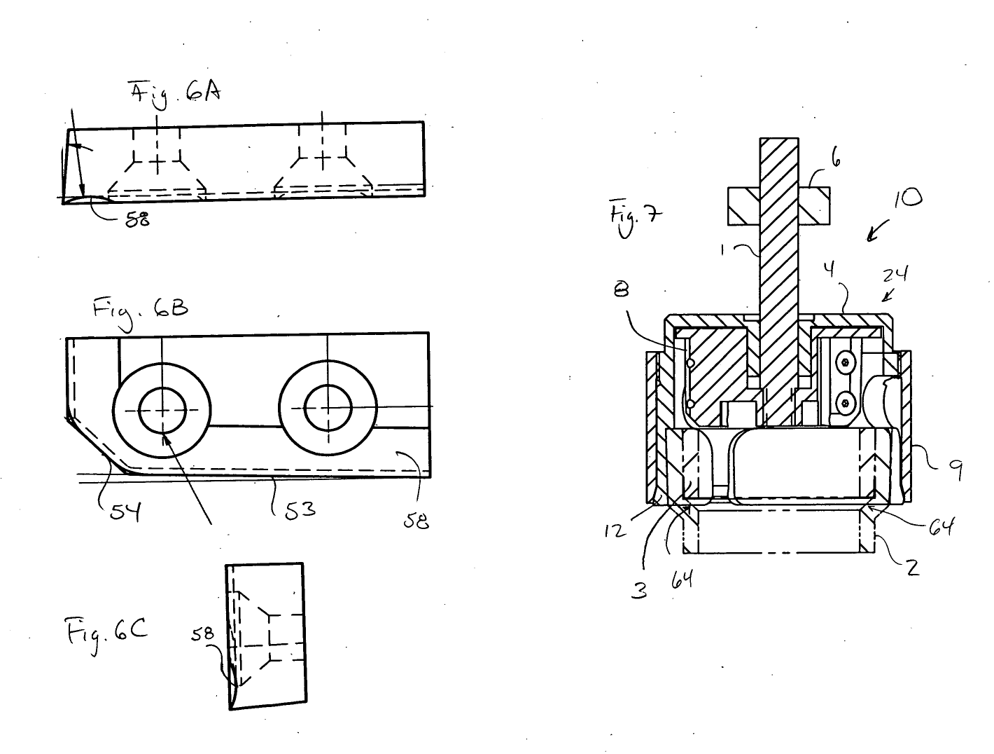

FIGS. 6A-6C is one embodiment of blades in accordance with the present invention.

FIG. 7 is a cross sectional view of the device of FIG. 1 mounted to a plastic pipe joint in accordance with the present invention.

### DETAILED DESCRIPTION

Referring to FIG. 1, an exploded perspective view of a device 10 for cutting the inner pipe member of a plastic pipe joint in accordance with the present invention is shown. Device 10 includes a plurality of components that may include the following.

Cutter head 5 has a plurality of blades 8 arranged substantially vertically and disposed outwardly. The blades may be attached by screws 7. The cutter head is coupled to one end of shaft 1. A stop collar 6 may be affixed to the shaft toward the end opposite the cutter head. Stop collar 6 may be attached by screw 19. Bushing 4 may have a plurality of teeth or fingers 12 that in use may be configured to fit over and resealably coupled to an outer pipe member 13. The collet screw 9 mounts to bushing 4 and rotation of screw 9 onto the bushing exerts a pressure on fingers 12 that cause them to contact and securely mount onto outer pipe member 13. Bushing 4 and screw 9 effectively form collet 24.

Head 5 may include a disc 15 and a blade support structure 16. Bushing 4 includes a cylindrical shaft guide 14 (see FIGS. 4A-4C) through which shaft 1 is positioned and may move freely. In use, the collet is slid down shaft 1 and placed about outer pipe member 13 and tightened. The shaft is then pushed downward until cutter head 5 engages inner pipe member 3. Rotation of shaft 1 causes movement of blades 8 which begin to cut away inner pipe member 3.

Referring to FIG. 2, a non-exploded perspective view of device 10 in accordance with the present invention is shown. In the perspective of FIG. 2, shaft 1 is not fully inserted into collet 24.

FIG. 2 illustrates the outer pipe member in phantom lines, fingers 12 of collet 24, and a portion of a blade 8 attached to blade support structure 16. Bushing screw 9, depth collar 6 and a portion of shaft 1 are also shown.

Referring to FIGS. 3A-3C, a bottom plan view, a side elevation and a cross-sectional view of cutter head 5 in accordance with the present invention are shown. Head 5 may include support disk 15 and blade support structure 16. FIG. 3A illustrates three blade supporting members 32, though it should be recognized that more or fewer blade support members may be utilized and support structure 16 may have other, including non-finger-like, configurations. Holes 31 may receive blade mounting screws.

FIG. 3B illustrates edge 33 and angled section 34 which may conform to the shape of a blade mounted thereon. A blade is preferably attached to each support member 32.

Referring to FIGS. 4A-4C and 5A-5B, various views of the component parts of collet 24 in accordance with the present invention are shown. FIGS. 4A-4C illustrate bushing 4 having a base 41 from which extend fingers 12. The base also includes an opening 14 and a circumferentially disposed threaded set region 44 which received the complementarily configured threads in collet 25 screw 9.

FIGS. 5A-5B illustrate the collet screw 9. The collet screw may include a wall section 47 which contacts the outer surface of fingers 12 to force them into secure contact with an outer pipe member and a threaded section 48 that mounts to threaded section 44 of bushing 4.

While three fingers 12 are shown, any suitable number of fingers may be utilized. Similarly, any suitable structure for releasable, yet securely mounting to an outer pipe member, and that includes an opening for shaft 1 or other suitable configuration, may be utilized.

Referring to FIGS. 6A-6C, one embodiment of blades 8 in accordance with the present invention is shown. In this embodiment, blades 8 have a slightly tapered side section 53 and a more pronounced angled section 54. The angled section 54 approximates the typical geometry of the remaining outer pipe member. As a result, the geometry of the outer pipe section prior to joint formation is more likely to be maintained through the inner pipe member removal process. It should be recognized that while side section 53 has a slight taper these sections may be non-tapered or otherwise configured. Blades 8 may also include a curved recess 58 or the like that improves cutting.

FIG. 7 illustrates a cross sectional view of device 10 mounted to a plastic pipe joint in accordance with the present invention. Collet screw 9 is turned pushing fingers 12 into secure contact with outer pipe member 2. The head 5 is then positioned above the inner pipe member with the edge of blades 8 aligned with the inner pipe member. Shaft 1 is rotated and descends until collar 6 contacts bushing 4. As this shaft rotates, blades 8 turn and begin to cut away at the inner pipe member 3. Cutting is limited by stop collar 6 or when disk 15 contacts the outer pipe member (though disk 15 may be configured to fit within the outer pipe member). Blade 8 may have an angled section 54 shaped similarly to the angled section 64 typically found in outer pipe members. Thus, if head 5 descends past removed inner pipe member and contacts the outer pipe member, the configuration of the outer pipe member is generally maintained, thereby maintaining the structural integrity of that member.

It should be recognized that the blades shown in FIG. 3B may have on outside edge that is tapered 1-5% degrees from vertical and preferably about 2 degrees. The bottom outside corner region may be angled 30 degrees or more from vertical, between 40 and 50 degrees from vertical and more preferably at approximately 45 degrees from vertical.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A device for removing an inner pipe member of a plastic pipe joint, comprising:
a housing configured for removable fixedly-secure coupling to the outside of a pipe joint;
a blade structure having a blade section that has a plurality of outwardly and circumferentially disposed blades; and
a shaft member coupled through the housing to the blade structure and configured such that rotation of the shaft member achieves rotation of the blade structure within the housing when the housing is fixedly-secured to the outside of a pipe joint.

2. The device of claim 1, wherein each of the plurality of blades has a bottom outside corner region that is angled downwardly and inwardly at an angle of approximately 30 degrees or more from vertical.

3. The device of claim 1, wherein each of the plurality of blades has a gradual inward taper from top to bottom of approximately 1-5% from vertical.

4. The device of claim 1, wherein each of the plurality of blades has a gradual inward taper from top to bottom and further includes an outside bottom corner region that is angled downwardly and inwardly at an angle of approximately 30 degrees or more from vertical.

5. The device of claim 1, wherein each of the plurality of blades has a gradual inward taper from top to bottom of approximately 1-4 degrees and further includes a outside bottom corner region that is angled downwardly and inwardly at an angle of approximately 40-50 degrees from vertical.

6. The device of claim 1, wherein the blade section is removable.

7. The device of claim 1, wherein each of the plurality of blades is individually removable.

8. The device of claim 1, wherein the housing includes a mechanism for removable fixedly-secure coupling to the outside of a pipe joint, the mechanism including a hand operable threaded member that permits a user to release, reposition and securely attach the housing to the outside of a pipe joint due to rotation based movement of the threaded member.

9. The device of claim 8, wherein the removable fixedly securing mechanism includes a collett having a plurality of collett fingers and a collett ring.

10. A device for removing an inner pipe member of a plastic pipe joint, comprising:
a housing configured for removable coupling to the outside of a pipe joint;
a blade structure having a blade section that has a plurality of outwardly and circumferentially disposed blades; and
a shaft member coupled through the housing to the blade structure and configured such that rotation of the shaft member achieves rotation of the blade structure within the housing when the housing is fixedly-secured to the outside of a pipe joint;
wherein each of the plurality of blades has a bottom outside corner region that is angled downwardly and inwardly at an angle of approximately 30 degrees or more from vertical.

11. The device of claim 10, wherein the housing includes a mechanism for removable fixedly-secure coupling to the outside of a pipe joint, the mechanism including a hand operable member that permits a user to release, reposition and securely attach the housing to the outside of a pipe joint.

12. The device of claim 11, wherein the removable fixedly securing mechanism includes a collett having a plurality of collett fingers and a collett ring.

13. The device of claim 10, wherein each of the plurality of blades has a gradual inward taper from top to bottom of approximately 1-5 degrees and further includes a outside bottom corner region that is angled downwardly and inwardly at an angle of approximately 40-50 degrees from vertical.

14. The device of claim 10, wherein each of the plurality of blades is individually removable.

15. A device for removing an inner pipe member of a plastic pipe joint, comprising:
a housing configured for removable coupling to the outside of a pipe joint;
a blade structure having a blade section that has a plurality of outwardly and circumferentially disposed blades; and
a shaft member coupled through the housing to the blade structure and configured such that rotation of the shaft member achieves rotation of the blade structure within the housing when the housing is fixedly-secured to the outside of a pipe joint;
wherein each of the plurality of blades is individually removable.

16. The device of claim 15, wherein the housing includes a mechanism for removable fixedly-secure coupling to the outside of a pipe joint, the mechanism including a hand operable member that permits a user to release, reposition and securely attach the housing to the outside of a pipe joint.

17. The device of claim 16, wherein the removable fixedly securing mechanism includes a collett having a plurality of collett fingers and a collett ring.

18. The device of claim 15, wherein each of the plurality of blades has a bottom outside corner region that is angled downwardly and inwardly at an angle of approximately 30 degrees or more from vertical.

19. The device of claim 15, wherein each of the plurality of blades has a gradual inward taper from top to bottom of approximately 1-5 degrees and further includes a outside bottom corner region that is angled downwardly and inwardly at an angle of approximately 40-50 degrees from vertical.
